(19) United States
(12) Patent Application Publication
(10) Pub. No.: US 2015/0162791 A1
(43) Pub. Date: Jun. 11, 2015

(54) ROTOR AND MOTOR INCLUDING THE SAME

(71) Applicant: LG INNOTEK CO., LTD., Seoul (KR)

(72) Inventor: Joon Keun WOO, Seoul (KR)

(73) Assignee: LG INNOTEK CO., LTD.

(21) Appl. No.: 14/563,277

(22) Filed: Dec. 8, 2014

(30) Foreign Application Priority Data
Dec. 9, 2013 (KR) 10-2013-0152228

(51) Int. Cl. H02K 1/27

(52) U.S. Cl. CPC H02K 1/2773

(57) ABSTRACT

A rotor may include a non-magnetic member including a through hole in which a rotational shaft is inserted, a plurality of core members received in the non-magnetic member and arranged radially with respect to the through hole to form pockets, and a plurality of magnets inserted in the pockets. An outer circumferential surface of the magnet is covered with the non-magnetic member. A motor including such rotor may be achieved.

### CROSS-REFERENCE TO RELATED APPLICATION

This application claims priority under 35 U.S.C. §119 to Korean Application No. 10-2013-0152228 filed on Dec. 9, 2013, whose entire disclosure is incorporated herein by reference.

### BACKGROUND

1. Field

The present application relates to a rotor mounted to a motor.

2. Background

In a general motor, a rotor is rotated by electromagnetic interaction between the rotor and a stator. At this time, a rotational shaft inserted in the rotor is also rotated to generate a rotational driving force. The rotor consists of a rotor core and a magnet. Depending on a coupling structure of the magnet provided on a rotor core, the rotor is classified into an SPM type rotor in which a magnet is placed on a rotor surface and an interior permanent magnet (IPM) type rotor.

In the above kinds of rotors, the IPM type rotor includes a cylindrical hub in which a rotational shaft is inserted, core members which are radially coupled to the hub, and a magnet inserted between the core members. In an assembling process, however, when the core member is forcedly press-fitted in the hub, the core member may be damaged. In addition, since the hub, the core members, and the magnet are manually assembled, the concentricity is not maintained, and the manufacturing cost is increased due to a number of elements to be assembled.

### BRIEF DESCRIPTION OF THE DRAWINGS

The embodiments will be described in detail with reference to the following drawings in which like reference numerals refer to like elements wherein:

FIG. 1 is a conceptual view of a motor according to one embodiment of the present application;

FIG. 2 is a perspective view of a rotor according to one embodiment of the present application;

FIG. 3 is a partial plan view of a rotor according to one embodiment of the present application;

FIG. 4 is a perspective view showing a state where a rotor according to one embodiment of the present application is coupled to a rotational shaft;

FIG. 5 is a perspective view showing a state where a rotor according to one embodiment of the present application is coupled to a rotational shaft, and viewed in another direction; and

FIG. 6 is a conceptual view illustrating an injection-molded state of a non-magnetic member according to one embodiment of the present application.

### DETAILED DESCRIPTION

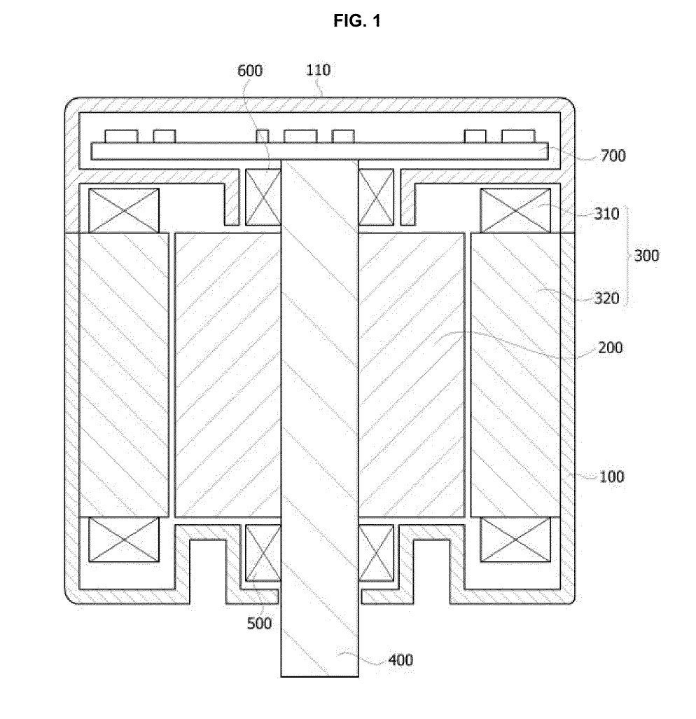

FIG. 1 is a view of a motor according to one embodiment of the present application. A motor includes a housing 100, a stator 300 disposed in the housing 100, a rotor 200 which is rotatably disposed in the stator 300, and a rotational shaft 400 passing through and inserted in the rotor 200 to allow the rotor and the rotational shaft to be integrally rotated.

The housing 100 has a cylindrical shape and is provided with a space formed therein so that the stator 300 and the rotor 200 can be mounted in the space. At this time, a shape or material for the housing 100 may be variously changed. However, a metal material which can withstand a high temperature may be selected for the housing 100.

The housing 100 is coupled to a cover 110 to shield the stator 300 and the rotor 200 from the outside. In addition, the housing 100 may further include a cooling structure for easily discharging internal heat. An air-cooling type cooling structure or a water-cooling type cooling structure may be selected and employed as such a cooling structure, and the shape of the housing 100 may be properly modified depending on the cooling structure.

The stator 300 is inserted into an internal space of the housing 100. The stator 300 includes a stator core 320 and a coil 310 wound around the stator core 320. An integral-type core formed in a ring shape or a core formed by coupling a plurality of split cores to each other may be employed as the stator core 320.

According to the type of the motor, the stator may be appropriately modified. In the DC motor, for example, the coil may be wound around the integral-type stator core. Also, the three-phase AC motor may be manufactured such that U, V, and W phases are applied to a plurality of coils, respectively.

The rotor 200 is disposed adjacent to the stator 300. A magnet is mounted to the rotor 200 so that the rotor is rotated due to an electromagnetic interaction between the rotor 200 and the stator 300.

The rotational shaft 400 is coupled to a central portion of the rotor 200. In a case where the rotor 200 is thus rotated, the rotational shaft 400 is rotated together with the rotor. The rotational shaft 400 may be supported by a first bearing 500 provided at one side thereof and a second bearing 600 provided at the other side. A plurality of electronic components are mounted on a circuit board 700. A hole integrated circuit detecting a rotation of the rotor 200 or an inverter may be mounted to the circuit board 700.

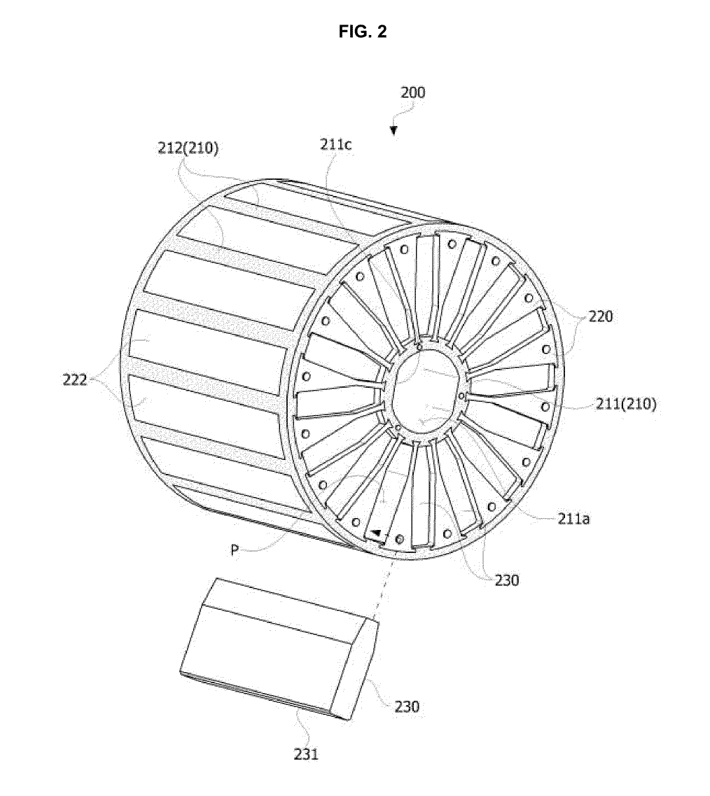

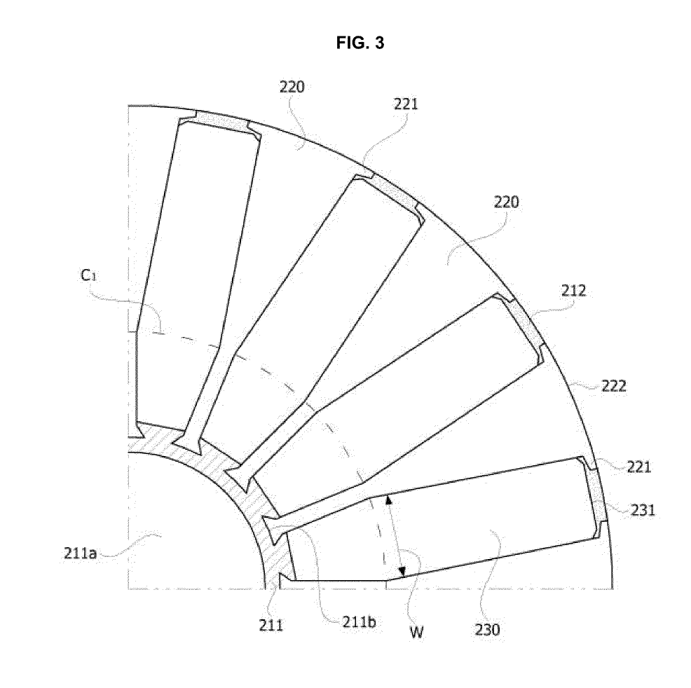

FIG. 2 is a perspective view of the rotor according to one embodiment of the present application, and FIG. 3 is a partial plan view of the rotor according to one embodiment of the present application. The rotor 200 includes a cylindrical non-magnetic member 210, a plurality of core members 220 which are radially disposed to form pockets P, and a plurality of magnets 230 inserted in the pockets P, respectively.

If the non-magnetic member 210 has a configuration by which the core member 220 and the magnet 230 can be secured, there is no particular limitation to the non-magnetic member. For example, in a state where the core members 220 are radially disposed in a mold, an injection molding process can be performed to manufacture the non-magnetic member 210. The magnet 230 is then inserted in the pocket P.

As another example, the non-magnetic member 210 may be formed by integrally injection-molding the non-magnetic member 210, the core member 220, and the magnet 230. As still another example, after the cylindrical non-magnetic member 210 on which a plurality of insertion holes are formed is pre-manufactured, the core members 220 and the magnets 230 may be inserted in the non-magnetic member, respectively.

If a material can shield magnetic force, any material can be employed for forming the non-magnetic member 210 without any limitation. In this embodiment, the non-magnetic member formed of resin is illustrated.

More concretely, the non-magnetic member 210 includes a central part 211 including a through hole 211a in which the rotational shaft 400 is inserted, a lateral part 212 covering an outer circumferential surface of the magnet 230 and a connecting part 213 connecting the central part 211 and the lateral part 212 to each other.

The through hole 211a in which the rotational shaft 400 is inserted is formed in the central part 211. A planation surface 211c may be formed on an inner wall of the through hole 211a or the through hole may have an elongated-hole shape. According to this configuration, the rotor of the present application is advantageous in that a slip of the rotational shaft 400 can be prevented.

An outer circumferential surface of the central part 211 is in contact with an inner end portion of the magnet 230 to secure the magnet 230 and to prevent the magnetic force from leaking to an outside through the through hole 211a. In addition, the outer circumferential surface of the central part 211 has a plurality of insertion grooves 211b formed thereon, and an end portion of the core member 220 is coupled to the insertion groove. The insertion groove 211b is extended in the axial direction.

Since the core member 220 is securely fixed to the non-magnetic member 210, a problem that the magnet 230 is separated from the core member 220 even when the motor is driven at high speed is prevented. The insertion groove 211b may be formed such that a width is increased towards the through hole 211a (taper shape) to increase a coupling force between the core member 220 and the central part 211.

The lateral part 212 is formed such that an outer circumferential surface 222 of the core member 220 is exposed to an outside and an outer circumferential surface 231 of the magnet 230 is covered with the lateral part. Thus, a problem that the magnet 230 is separated from the pocket P is prevented. According to the manufacturing method, the lateral part 212 may be adhered to the outer circumferential surface 231 of the magnet 230.

The core members 220 are disposed in the non-magnetic member 210 and are radially arranged with respect to the through hole 211a. The pocket P may be defined as a space formed by the central part 211 and lateral part 212 of the non-magnetic member and the adjacent the core member 220.

The core member 220 is formed of a metal material and forms a magnetic flux path between the magnets 230. An inner end portion of the core member 220 is secured to the insertion groove 211b of the central part 211 and the outer circumferential surface 222 is exposed to an outside of the non-magnetic member 210. The exposed outer circumferential surface 222 may have a curvature which is substantially the same as a curvature of an outer circumferential surface of the non-magnetic member 210.

The core member 220 may have engagement protrusions 221 formed on the outer circumferential surface 222 thereof and extended in the directions which are opposite to each other, respectively. The magnet 230 is engaged to these engagement protrusions. The engagement protrusions 221 restrict the magnet 230 to prevent a separation of the magnet at the time of operating the motor.

The magnets 230 may be disposed into a concentrated flux type spoke formation. The magnets 230 are magnetized in the circumferential direction and are disposed such that a polarity of one magnet faces the same polarity of the adjacent magnet. The magnet 230 may be formed such that a width W of the magnet is reduced towards the through hole 211a from a point corresponding to an imaginary line C1 which has a curvature/diameter larger than that of the through hole 211a.

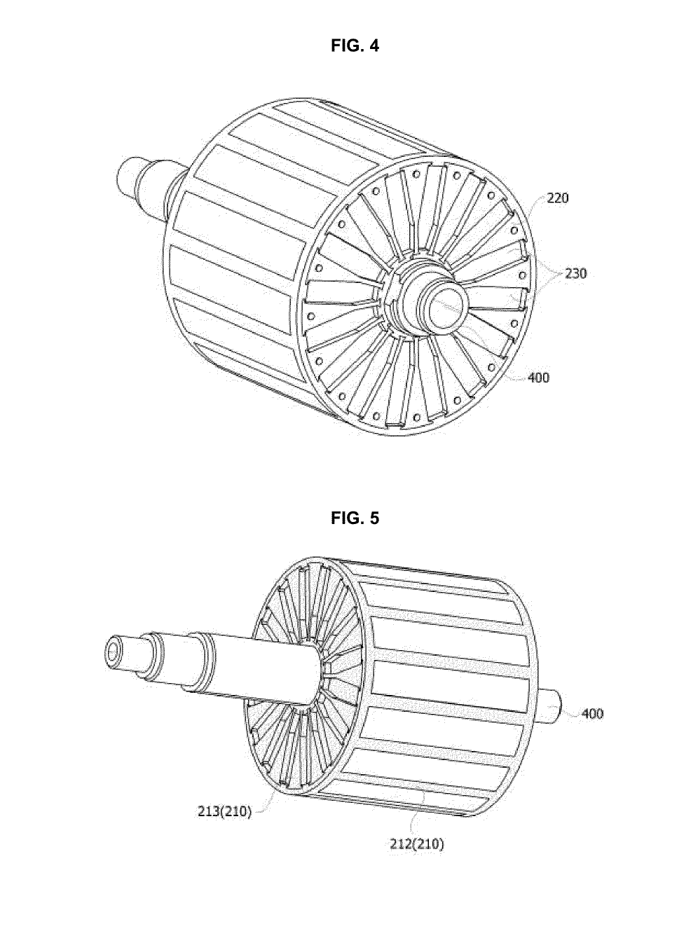

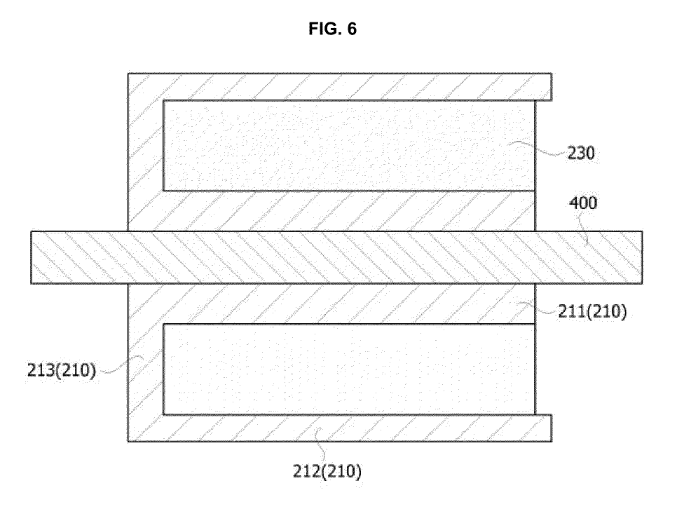

FIG. 4 is a perspective view showing a state where the rotor according to one embodiment of the present application is coupled to the rotational shaft, FIG. 5 is a perspective view showing a state where the rotor according to one embodiment of the present application is coupled to the rotational shaft, and viewed in another direction, and FIG. 6 is a conceptual view illustrating an injection-molded state of the non-magnetic member according to one embodiment of the present application.

Referring to FIG. 5 and FIG. 6, the connecting part 213 of the non-magnetic member 210 is formed on an entire lower surface of the rotor 200 to connect the central part 211 and the lateral part 212 to each other. The lower surface on which the connecting part 213 is formed may be the surface facing the direction in which resin is injected at the time of carrying out an injection-molding process. Accordingly, the lower surface may have a shape (for example, a groove) corresponding to a resin nozzle utilized in an injection-molding process.

The magnet 230 and the core member 220 are sealed by the central part 211, the connecting part 213, and the lateral part 212 of the non-magnetic member 210. The connecting part 213 may be also formed on an upper surface of the rotor 200.

According to the above configuration, since the cylindrical non-magnetic member 210 and the core member 220 are formed integrally with each other by an injection-molding process, the assembling process can be easily performed and it is possible to reduce a slip torque.

According to the present application, since the elements constituting the rotor are assembled integrally with other, dimensional accuracy is enhanced and it is possible to prevent a slip torque from being generated.

In addition, since the elements constituting the rotor are assembled integrally with other, dimensional accuracy is enhanced when the magnet is inserted.

Furthermore, since the magnet is covered with the non-magnetic member, it is possible to prevent the magnet from being separated when the motor is driven at a high speed.

Due to an integral assembling process, it is possible to reduce the manufacturing cost.

A rotor may be produced by a simple assembling process, and a motor including the same. A separation of a magnet may be prevented, and a motor including the same.

A rotor may include a cylindrical non-magnetic member including a through hole in which a rotational shaft is inserted; a plurality of core members received in the non-magnetic member and arranged radially with respect to the through hole to form pockets; and a plurality of magnets inserted in the pockets. An outer circumferential surface of the magnet is covered with the non-magnetic member. An outer circumferential surface of the core member may be exposed to an outside of the non-magnetic member.

The core member may include engagement protrusions protruded in the directions which are opposite to each other, and the outer circumferential surface of the core member, which is exposed between the engagement protrusions of two adjacent core members, is covered with the non-magnetic member. The outer circumferential surface of the core member may have a curvature which is the same as the curvature of the outer circumferential surface of the cylindrical non-magnetic member.

The non-magnetic member may include a central part having a through hole in which the rotational shaft is inserted, a lateral part covering an outer circumferential surface of the magnet, and a connecting part connecting the central part and the lateral part to each other.

The connecting part may be formed on at least one of one surface and the other surface of the rotor to connect the central part and the connecting part. The central part may include a plurality of insertion grooves formed on an outer circumferential surface thereof, and each of the insertion groove is coupled with an end portion of the core member.

The insertion groove may be extended in the axial direction, and a plurality of insertion grooves are formed along an outer circumferential surface of the central part. The insertion groove may have a width which is increased towards an inside of the central part.

The magnet may have a width which is reduced towards the through hole from a point corresponding to an imaginary line which has a curvature/diameter larger than that of the through hole.

In the rotor according to a preferred embodiment of the present application, the non-magnetic member may be injection-molded integrally with the core member and the magnet. The through hole includes a planation surface formed on an inner wall thereof.

A motor may include a housing; a stator disposed in the housing; a rotor which is rotatably disposed in the stator; and a rotational shaft which is rotated integrally with the rotor. Here, the rotor includes a non-magnetic member having a through hole in which a rotational shaft is inserted; a plurality of core members received in the non-magnetic member and arranged radially with respect to the through hole to form pockets; and a plurality of magnets inserted in the pockets. In addition, an outer circumferential surface of the magnet is covered with the non-magnetic member.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A rotor comprising:
a non-magnetic member including a through hole configured to receive a rotational shaft is inserted;
a plurality of core members provided in the non-magnetic member and arranged radially with respect to the through hole to form pockets; and
a plurality of magnets arranged in the pockets.

2. The rotor of claim 1, wherein an outer circumferential surface of the magnet is covered with the non-magnetic member.

3. The rotor of claim 1, wherein an outer circumferential surface of the core member is exposed to an outside of the non-magnetic member.

4. The rotor of claim 1, wherein the core member comprises engagement protrusions protruding in opposite directions, and the outer circumferential surface of the core member, which is exposed between the engagement protrusions of two adjacent core members, is covered with the non-magnetic member.

5. The rotor of claim 3, wherein the outer circumferential surface of the core member has a curvature which is the same as the curvature of the outer circumferential surface of the non-magnetic member.

6. The rotor of claim 1, wherein the non-magnetic member comprises a central part including the through hole, a lateral part covering an outer circumferential surface of the magnet, and a connecting part connecting the central part and the lateral part to each other.

7. The rotor of claim 6, wherein the connecting part is formed on at least one of one surface and the other surface of the rotor to connect the central part and the connecting part.

8. The rotor of claim 6, wherein the central part comprises a plurality of insertion grooves formed on an outer circumferential surface thereof, and each of the insertion groove is coupled with an end portion of the core member.

9. The rotor of claim 8, wherein the insertion groove is extended in the axial direction, and a plurality of insertion grooves are formed along an outer circumferential surface of the central part.

10. The rotor of claim 8, wherein the insertion groove has a width which is increased towards an inside of the central part.

11. The rotor of claim 1, wherein the magnet has a width which is reduced towards the through hole from a point corresponding to an imaginary line which has a curvature/diameter larger than that of the through hole.

12. The rotor of claim 1, wherein the non-magnetic member is injection-molded integrally with the core member and the magnet.

13. The rotor of claim 1, wherein the through hole comprises a planation surface formed on an inner wall thereof.

14. A motor comprising;
a housing;
a stator provided in the housing;
a rotor provided adjacent to the stator; and
a rotational shaft which rotates with the rotor,
wherein the rotor comprises a non-magnetic member including a through hole in which a rotational shaft is inserted; a plurality of core members received in the non-magnetic member and arranged radially with respect to the through hole to form pockets; and a plurality of magnets arranged in the pockets.

15. The motor of claim 14, wherein an outer circumferential surface of the magnet is covered with the non-magnetic member.

16. The motor of claim 15, wherein the core member comprises engagement protrusions protruding in opposite directions, and an outer circumferential surface of the core member, which is exposed between the engagement protrusions of two adjacent core members, is covered with the non-magnetic member.

17. The motor of claim 15, wherein the non-magnetic member comprises a central part including the through hole, a lateral part covering the outer circumferential surface of the magnet, and a connecting part connecting the central part and the lateral part to each other.

18. The motor of claim 17, wherein the connecting part is formed on at least one of one surface and the other surface of the rotor to connect the central part and the connecting part.

19. The motor of claim 17, wherein the central part comprises a plurality of insertion grooves formed on an outer circumferential surface thereof, and each of the insertion groove is coupled with an end portion of the core member.

20. The motor of claim 19, wherein the insertion groove is extended in the axial direction, and a plurality of insertion grooves are formed along an outer circumferential surface of the central part.
